(19) United States
(12) Patent Application Publication
(10) Pub. No.: US 2022/0039527 A1
(43) Pub. Date: Feb. 10, 2022

(54) WALKING CANE APPARATUS

(71) Applicant: Albert H. Kaner, Playa Vista, CA (US)

(72) Inventor: Albert H. Kaner, Playa Vista, CA (US)

(21) Appl. No.: 17/394,203

(22) Filed: Aug. 4, 2021

Related U.S. Application Data
(60) Provisional application No. 63/060,972, filed on Aug. 4, 2020.

(51) Int. Cl. A45B 3/00; A45B 9/02; A45B 9/04; A45B 3/04; A47G 25/82; B25G 1/04; B25J 1/04

(52) U.S. Cl. CPC A45B 3/00; A45B 9/02; A45B 9/04; A45B 2009/007; A47G 25/82; B25G 1/04; B25J 1/04; A45B 3/04

(57) ABSTRACT

Disclosed herein is a walking cane having a grabbing mechanism operable to extend away from a base of the apparatus. The cane comprises a hollow support shaft having an upper end proximate to and engaged with a handle, and a lower end proximate to and engaged with a base having a plurality of feet extending downward away; an inner chamber defined within the hollow shaft at least partially open on the lower end through a bottom opening in the base; and a grabbing mechanism disposed within the inner chamber comprising an actuator located proximate to the upper end mechanically coupled to a pincer assembly located proximate to the base, such that movement of the actuator in a first direction causes the pincer assembly to form a closed confirmation, and movement of the actuator in a second direction opposite the first direction causes the pincer assembly to form an open confirmation.

### RELATED APPLICATION

This application claims the benefit of a U.S. Provisional Application Ser. No. 63/060,972 filed Aug. 4, 2020, the disclosure of which is incorporated by reference herein in its entirety.

### BACKGROUND

The statements in this section merely provide background information related to the present disclosure and may not constitute prior art.

Walking canes and other support devices are utilized by a number of persons for various reasons. There is need in the art for more functional devices to assist in everyday needs and actions of the end users of such devices.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In embodiments, a support device, i.e., a walking cane comprises a hollow support shaft having an upper end proximate to and engaged with a handle, and a lower end proximate to and engaged with a base; the base comprising a plurality of feet extending at least partially downward away from the lower end, dimensioned and arranged to support the device on a surface; an inner chamber defined within the hollow shaft at least partially open on the lower end through a bottom opening disposed through the base; a grabbing mechanism at least partially disposed within the inner chamber comprising an actuator located proximate to the upper end mechanically coupled to a pincer assembly located proximate to the base, such that movement of the actuator in a first direction causes the pincer assembly to form a closed confirmation, and movement of the actuator in a second direction opposite the first direction causes the pincer assembly to form an open confirmation.

In an embodiment, a support device comprises a hollow support shaft having an upper end proximate to and engaged with a handle, and a lower end proximate to and engaged with a base; the base comprising a plurality of feet dimensioned and arranged to support the walking cane on a surface, extending downwardly away from the lower end; an inner chamber defined within the hollow shaft open on the lower end through a bottom opening disposed through the base between the plurality of feet; a grabbing mechanism slidably engaged with, and disposable within the inner chamber comprising an actuating end separated from a pincer end along a center shaft, an actuator arm having an actuator attachment end engaged with a point on the center shaft proximate to the actuator end and a distal actuator end extending away from the center shaft, wherein the actuator arm is dimensioned and arranged such that the distal actuator end protrudes through a corresponding opening in a side of the hollow support; a pincer arm having a pincer attachment end rotationally engaged with a point on the center shaft proximate to the pincer end and a distal pincer end extendable away from the center shaft; the actuator arm operably connected to the pincer arm such that movement of the distal actuator end in a first direction causes the distal pincer end to move toward the center shaft forming a closed confirmation, and movement of the distal actuator end in a second direction opposite the first direction causes the distal pincer end to move away from the center shaft forming an open conformation; the grabbing mechanism slidably engaged with the hollow shaft between a retracted position wherein the pincer attachment end is located within the inner chamber between the upper end of the hollow shaft and the bottom opening, and an extended position wherein the pincer attachment end is located outside of the inner chamber away from the bottom opening.

### BRIEF DESCRIPTION OF THE SEVERAL VIEWS OF THE DRAWINGS

Embodiments of the support device are described with reference to the following figures. The same numbers are used throughout the figures to reference like features and components.

FIG. 1A shows a rear facing view of a support device (i.e., a walking cane) according to embodiments disclosed herein;

FIG. 1B shows a right side view of the walking cane shown in FIG. 1A;

FIG. 1C shows a front view of the walking cane shown in FIG. 1A;

FIG. 1D shows a bottom view of the walking cane shown in FIG. 1A;

FIG. 2A shows a side view of a walking cane having an extendable handle according to embodiments disclosed herein;

FIG. 2B shows a partial front view of the support shaft shown in FIG. 2A;

FIG. 3 shows a partial cutaway view showing the grabbing mechanism engaged within an inner chamber of the hollow shaft in a retracted position according to embodiments disclosed herein;

FIG. 4 shows a partial cutaway view showing the grabbing mechanism engaged within an inner chamber of the hollow shaft in an extended position according to embodiments disclosed herein;

FIG. 5 shows a side view of the grabbing mechanism in an open conformation according to embodiments disclosed herein;

FIG. 6 shows a side view of the grabbing mechanism shown in FIG. 5 in a closed or grabbing conformation after actuation according to embodiments disclosed herein;

FIG. 7A shows a partial cutaway view showing an alternative grabbing mechanism equipped with a shoehorn engaged within an inner chamber of the hollow shaft in a retracted position according to embodiments disclosed herein;

FIG. 7B shows a bottom view of the embodiment shown in FIG. 7A;

FIG. 8 shows a partial cutaway view showing an alternative grabbing mechanism equipped with a shoehorn engaged within an inner chamber of the hollow shaft in an extended position according to embodiments disclosed herein;

FIG. 9 shows a front on view of the lighted handle portion the embodiment shown in FIG. 8;

FIG. 10 shows the shoehorn mechanism of the embodiment shown in FIG. 8.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. As used in the specification and claims, “near” is inclusive of “at”.

As used herein, a support device refers to an ambulatory device which provides the user with support for treatment of various gait disorders. Support devices include walking canes, walkers, and the like as commonly understood in the art suitable to bear the weight of the user during ambulation and/or standing. For purposes herein, the terms “support device” and “walking cane” are used interchangeably.

In embodiments, a support device (e.g, a walking cane) comprises a hollow support shaft having an upper end proximate to and engaged with a handle, and a lower end proximate to and engaged with a base. The base comprises a plurality of feet extending at least partially downward away from the lower end, dimensioned and arranged to support the device on a surface. These feet may further include rubber or other non-slide pads as is common in the art. The support device further includes an inner chamber defined within the hollow shaft at least partially open on the lower end through a bottom opening disposed through the base and a grabbing mechanism at least partially disposed within the inner chamber comprising an actuator located proximate to the upper end mechanically coupled to a pincer assembly located proximate to the base, such that movement of the actuator in a first direction causes the pincer assembly to form a closed confirmation, and movement of the actuator in a second direction opposite the first direction causes the pincer assembly to form an open confirmation.

In embodiments, the grabbing mechanism is slidably engaged with the inner chamber, wherein the actuator is located on an actuating end, the pincer assembly is located on and/or integral to a pincer end, and the actuator end is separated from the pincer end along a center shaft; the actuator comprising an actuator arm having an actuator attachment end engaged with a point on the center shaft proximate to the actuator end and a distal actuator end extending away from the center shaft, wherein the actuator arm is dimensioned and arranged such that at least a portion of the distal actuator end protrudes through a corresponding opening in a side of the hollow support.

In some embodiments of the support device, the pincer assembly comprises a pincer arm having a pincer attachment end rotationally engaged with a point on the center shaft proximate to the pincer end, and a distal pincer end extendable away from the center shaft. In embodiments, the support device may further comprise an illumination device, e.g., a battery operated flashlight located within the handle and/or a personal safety alarm triggerable by the user which is capable of providing an attention getting signal (e.g., a loud noise or siren) to direct attention to the end user should assistance be required.

In embodiments, the actuator arm is operably connected to the pincer arm such that movement of the distal actuator end in the first direction causes the distal pincer end to move toward the center shaft forming the closed confirmation, and movement of the distal actuator end in the second direction opposite the first direction causes the distal pincer end to move away from the center shaft forming the open conformation. In embodiments, the support device may further comprise a shoehorn assembly rotationally engaged with the pincer end of the center shaft, movable between an open position and a closed position. In some embodiments, the pincer assembly is biased to remain in the open conformation.

In embodiments, the grabbing mechanism is slidably engaged with, and disposed within the hollow shaft, and comprising a retracted position wherein the pincer attachment end is located at least partially within the inner chamber between the upper end of the hollow shaft and the bottom opening, and an extended position wherein at least a portion of the pincer attachment end is located outside of the inner chamber away from the bottom opening. In embodiments, at least a portion of the grabbing mechanism extends a distance away from the base which is greater than a distance that the plurality of feet extend away from the base when the grabbing mechanism is in the extended position.

In one or more embodiments, a distance between the handle and the base is adjustable. In some embodiments, the upper end of the hollow support is telescopically engaged with the lower end and further comprises a push-button engagement mechanism positioned to engage one or more of a plurality of corresponding holes disposed through the lower end of the hollow support thereby rendering the distance between the handle and the base adjustable.

In embodiments, a support device comprises a hollow support shaft having an upper end proximate to and engaged with a handle, and a lower end proximate to and engaged with a base; the base comprising a plurality of feet dimensioned and arranged to support the walking cane on a surface, extending downwardly away from the lower end; an inner chamber defined within the hollow shaft open on the lower end through a bottom opening disposed through the base between the plurality of feet; a grabbing mechanism slidably engaged with, and disposable within the inner chamber comprising an actuating end separated from a pincer end along a center shaft, an actuator arm having an actuator attachment end engaged with a point on the center shaft proximate to the actuator end and a distal actuator end extending away from the center shaft, wherein the actuator arm is dimensioned and arranged such that the distal actuator end protrudes through a corresponding opening in a side of the hollow support; a pincer arm having a pincer attachment end rotationally engaged with a point on the center shaft proximate to the pincer end and a distal pincer end extendable away from the center shaft; the actuator arm operably connected to the pincer arm such that movement of the distal actuator end in a first direction causes the distal pincer end to move toward the center shaft forming a closed confirmation, and movement of the distal actuator end in a second direction opposite the first direction causes the distal pincer end to move away from the center shaft forming an open conformation; the grabbing mechanism slidably engaged with the hollow shaft between a retracted position wherein the pincer attachment end is located within the inner chamber between the upper end of the hollow shaft and the bottom opening, and an extended position wherein the pincer attachment end is located outside of the inner chamber away from the bottom opening.

In some of such embodiments, the upper end of the hollow support is telescopically engaged with the lower end and further comprises a push-button engagement mechanism positioned to engage one or more of a plurality of corresponding holes disposed through the lower end of the hollow support thereby rendering the distance between the handle and the base adjustable, and/or the support device further comprises a shoe horn assembly rotationally engaged with the pincer end of the center shaft, movable between an open position and a closed position and/or an illumination device and/or attention directing device located within the handle.

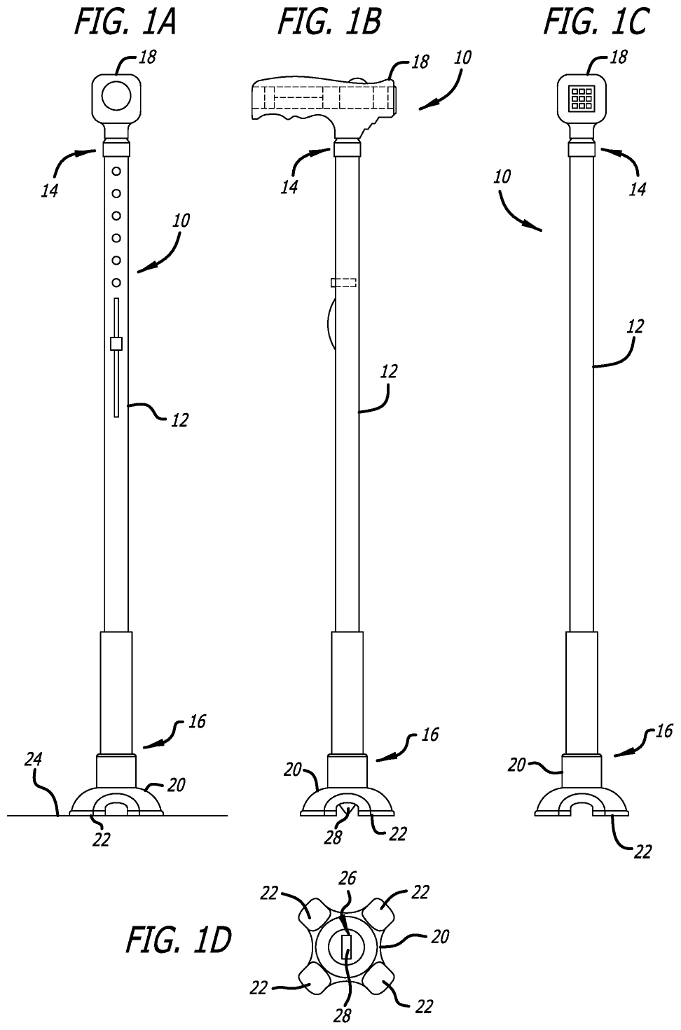

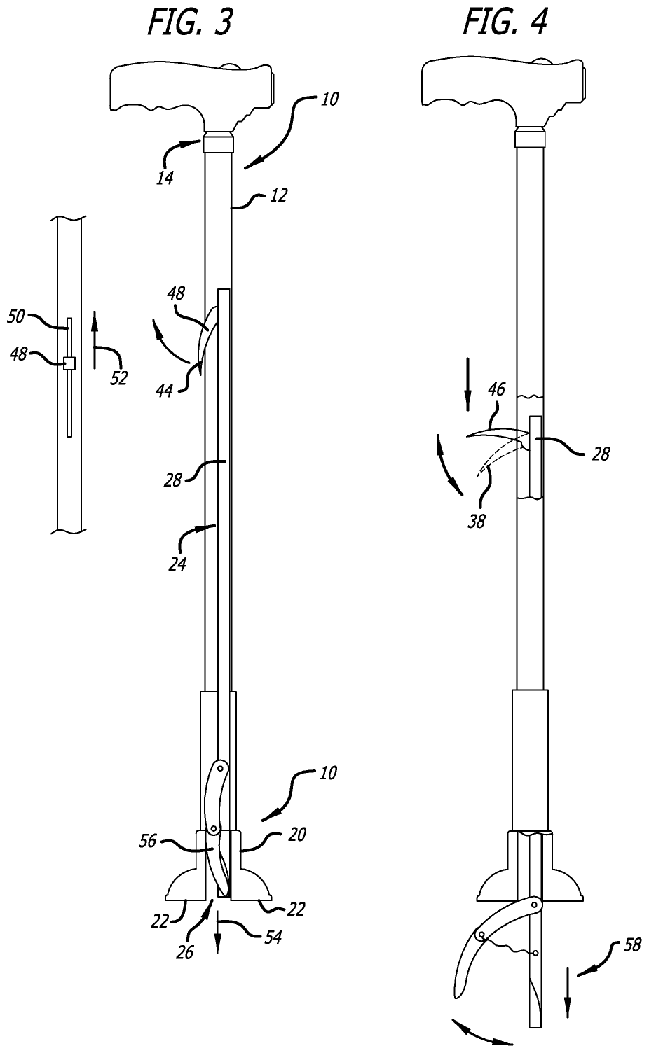

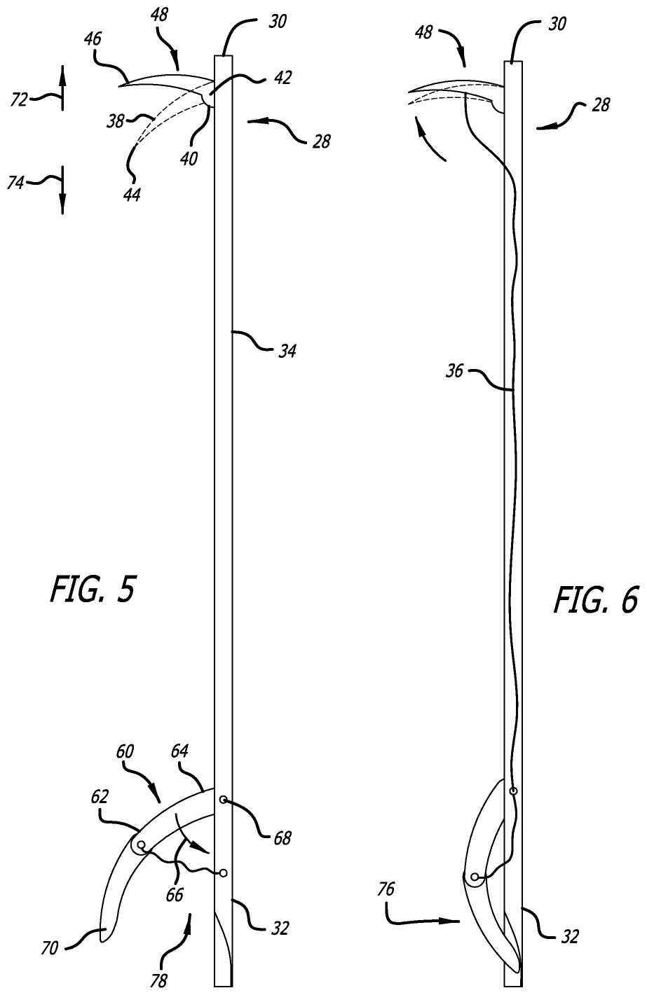

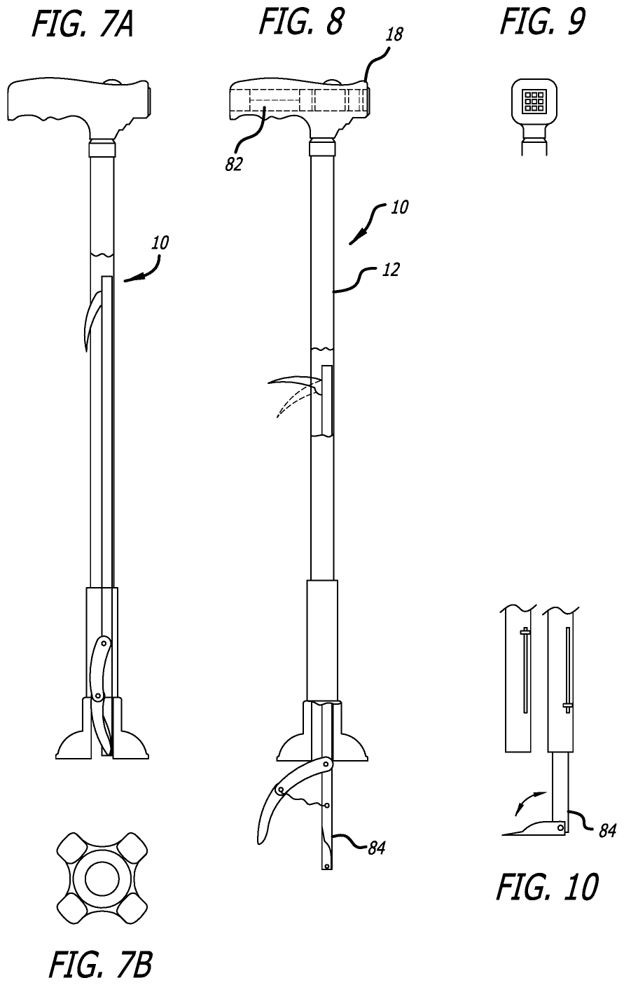

As shown in FIGS. 1A-1D, in embodiments, a walking cane, generally referred to as 10, comprises a hollow support shaft 12 having an upper end 14 proximate to and engaged with a handle 18, and a lower end 16 proximate to and engaged with a base 20; base 20 comprising a plurality of feet 22 dimensioned and arranged to support the walking cane 10 on a surface 24, the feet 22 extending both outwardly away from the hollow support shaft 12 and downwardly away from the lower end 16. As shown in FIG. 3, the hollow support shaft 12 forms an inner chamber 24 defined within the hollow support shaft which is open on the lower end 16 through a bottom opening 26 disposed through the base 20 between the plurality of feet 22. This is also shown in FIG. 1D. The bottom opening 26 is dimensioned to allow a portion of the grabbing mechanism 28 to slide therethrough. As shown in FIGS. 3 and 4, the grabbing mechanism 28 is slidably engaged with, and disposable within the inner chamber 24. As shown in FIGS. 5 and 6, in embodiments, grabbing mechanism 28 comprises an actuating end 30 separated from a pincer end 32 along a center shaft 34. In embodiments, the grabbing mechanism 28 comprises an actuator assembly 48 comprising an actuator arm 38 having an actuator attachment end 40 movably engaged with a point 42 on the center shaft 34 proximate to the actuator end 30, and a distal actuator end 44 extending away from the center shaft 34.

As shown in FIG. 5, in embodiments, the actuator assembly 38 may include a stationary handle 46 which remains stationary with respect to the actuator arm 38 and can be used as a leverage point to move the actuator arm 38 from one position to another. As shown in FIGS. 3 and 4, the actuator arm is dimensioned and arranged such that the distal actuator end 44 and the stationary handle 46 protrude through a corresponding opening 50 in a side of the hollow support 12. The grabbing mechanism 28 is slidably engaged within the hollow shaft between a retracted position 56 shown in FIG. 3 and an extended position 58 wherein the pincer assembly 60 is located outside of the inner chamber 24 away from the bottom opening 26 as shown in FIG. 4. As shown in FIG. 3, in embodiments, the stationary handle 46 may be hingedly attached to the center shaft 34 and have a portion which protrudes through opening 50 such that movement of the actuator assembly 48 in general, and handle 46 in particular, in a direction towards the upper end 14 (as indicated by 52) results in the grabbing mechanism 28 moving downwardly 54 from the retracted position 56 into the extended position 58.

As shown in FIGS. 5 and 6, the grabbing mechanism 28 further includes a pincer assembly 60 comprising a pincer arm 62 having a pincer attachment end 64 rotationally engaged 66 with a point 68 on the center shaft 34 proximate to the pincer end 32. The pincer arm 62 may also include a distal pincer end 70 extendable away from the center shaft 34.

In embodiments, the actuator arm 38 is operably connected, e.g., via cord or linkage 36 through a hollow center shaft 34, to the pincer arm assembly 60 such that movement of the distal actuator end 44 in a first direction indicated by arrow 72 causes the distal pincer end 44 to move from an outward position as shown in FIG. 5 toward the center shaft 34 forming a closed confirmation as shown in FIG. 6 and indicated by arrow 76. Movement of the distal actuator end 44 in a second direction 74 opposite the first direction 72 causes the distal pincer end 44 to move away from the center shaft 34 forming an open conformation as shown in FIG. 5 and indicated by arrow 78.

As shown in FIG. 3, the pincer assembly is dimensioned and arranged to fit within the inner chamber 24 of the hollow support shaft when the grabber mechanism 28 is in the retracted position 56, and to fit through the bottom opening 26 wherein the pincer assembly 60 takes the open configuration.

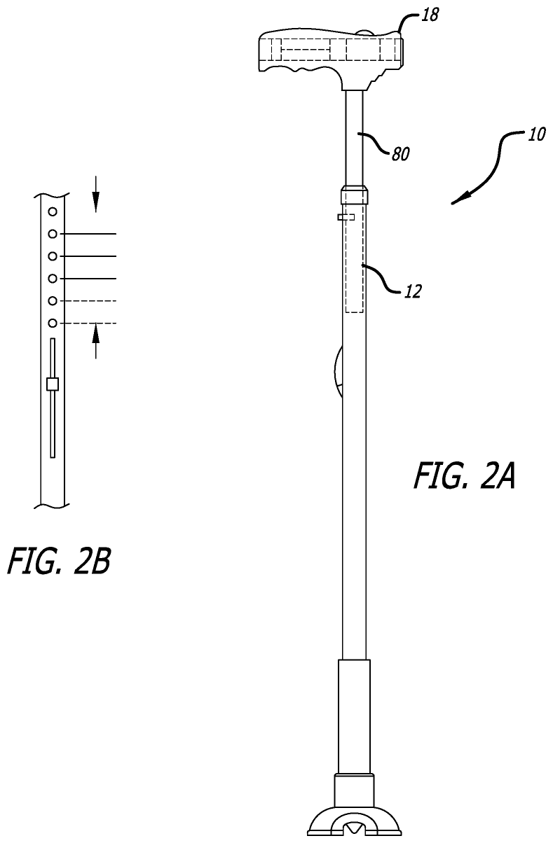

As shown in FIGS. 2A and 2B, in embodiments, the handle is attached to a telescoping engagement mechanism 80 and is capable of engaging the hollow support shaft 12 such that the handle is adjustable between a plurality of positions. In embodiments, this is push-button spring loaded ball and hole engagement as shown in FIG. 2B where the ball engages one of a plurality of holes disposed through the support shaft 12.

As shown in FIGS. 8 and 9, in embodiments, the handle 82 further includes one or more illumination devices 82, e.g., a battery operated LED device which may be turned on and off by a switch in the handle as shown in FIG. 8.

In other embodiments, or in addition, the walking cane 10 may further include a shoehorn slidingly engaged with the pincer end 32 of the grabbing mechanism 38 which is independently actionable between a concealed position and an extended position as shown in FIG. 10.

In other embodiments, or in addition, the walking cane 10 may further include an identification card holder comprising a frame forming an open face pocket. The frame of the identification card holder may be removably secured to the handle 18 and adapted to receive a card or other insert with identifying information.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

I claim:

1. A support device comprising:
a hollow support shaft having an upper end proximate to and engaged with a handle, and a lower end proximate to and engaged with a base;
the base comprising a plurality of feet extending at least partially downward away from the lower end, dimensioned and arranged to support the device on a surface;
an inner chamber defined within the hollow shaft at least partially open on the lower end through a bottom opening disposed through the base;
a grabbing mechanism at least partially disposed within the inner chamber comprising an actuator located proximate to the upper end mechanically coupled to a pincer assembly located proximate to the base, such that movement of the actuator in a first direction causes the pincer assembly to form a closed confirmation, and movement of the actuator in a second direction opposite the first direction causes the pincer assembly to form an open confirmation.

2. The support device of claim 1, wherein the grabbing mechanism is slidably engaged with the inner chamber,
wherein the actuator is located on an actuating end, the pincer assembly is located on and/or integral to a pincer end, and the actuator end is separated from the pincer end along a center shaft;
the actuator comprising an actuator arm having an actuator attachment end engaged with a point on the center shaft proximate to the actuator end and a distal actuator end extending away from the center shaft, wherein the actuator arm is dimensioned and arranged such that at least a portion of the distal actuator end protrudes through a corresponding opening in a side of the hollow support.

3. The support device of claim 2, wherein the pincer assembly comprises a pincer arm having a pincer attachment end rotationally engaged with a point on the center shaft proximate to the pincer end, and a distal pincer end extendable away from the center shaft.

4. The support device of claim 3, wherein the actuator arm is operably connected to the pincer arm such that movement of the distal actuator end in the first direction causes the distal pincer end to move toward the center shaft forming the closed confirmation, and movement of the distal actuator end in the second direction opposite the first direction causes the distal pincer end to move away from the center shaft forming the open conformation.

5. The support device of claim 4, further comprising a shoehorn assembly rotationally engaged with the pincer end of the center shaft, movable between an open position and a closed position.

6. The support device of claim 4, wherein the pincer assembly is biased to remain in the open conformation.

7. The support device of claim 4, wherein the grabbing mechanism is slidably engaged with, and disposed within the hollow shaft, and comprising a retracted position wherein the pincer attachment end is located at least partially within the inner chamber between the upper end of the hollow shaft and the bottom opening, and an extended position wherein at least a portion of the pincer attachment end is located outside of the inner chamber away from the bottom opening.

8. The support device of claim 7, wherein at least a portion of the grabbing mechanism extends a distance away from the base which is greater than a distance that the plurality of feet extend away from the base when the grabbing mechanism is in the extended position.

9. The support device of claim 1, further comprising an illumination device located within the handle.

10. The support device of claim 1 wherein a distance between the handle and the base is adjustable.

11. The support device of claim 10, wherein the upper end of the hollow support is telescopically engaged with the lower end and further comprises a push-button engagement mechanism positioned to engage one or more of a plurality of corresponding holes disposed through the lower end of the hollow support thereby rendering the distance between the handle and the base adjustable.

12. A support device comprising:
a hollow support shaft having an upper end proximate to and engaged with a handle, and a lower end proximate to and engaged with a base; the base comprising a plurality of feet dimensioned and arranged to support the walking cane on a surface, extending downwardly away from the lower end; an inner chamber defined within the hollow shaft open on the lower end through a bottom opening disposed through the base between the plurality of feet; a grabbing mechanism slidably engaged with, and disposable within the inner chamber comprising an actuating end separated from a pincer end along a center shaft, an actuator arm having an actuator attachment end engaged with a point on the center shaft proximate to the actuator end and a distal actuator end extending away from the center shaft, wherein the actuator arm is dimensioned and arranged such that the distal actuator end protrudes through a corresponding opening in a side of the hollow support; a pincer arm having a pincer attachment end rotationally engaged with a point on the center shaft proximate to the pincer end and a distal pincer end extendable away from the center shaft; the actuator arm operably connected to the pincer arm such that movement of the distal actuator end in a first direction causes the distal pincer end to move toward the center shaft forming a closed confirmation, and movement of the distal actuator end in a second direction opposite the first direction causes the distal pincer end to move away from the center shaft forming an open conformation; the grabbing mechanism slidably engaged with the hollow shaft between a retracted position wherein the pincer attachment end is located within the inner chamber between the upper end of the hollow shaft and the bottom opening, and an extended position wherein the pincer attachment end is located outside of the inner chamber away from the bottom opening.

13. The support device of claim 12, wherein the upper end of the hollow support is telescopically engaged with the lower end and further comprises a push-button engagement mechanism positioned to engage one or more of a plurality of corresponding holes disposed through the lower end of the hollow support thereby rendering the distance between the handle and the base adjustable.

14. The support device of claim 13, further comprising a shoe horn assembly rotationally engaged with the pincer end of the center shaft, movable between an open position and a closed position.

15. The support device of claim 13, further comprising an illumination device located within the handle.
